(19) United States
(12) Patent Application Publication
(10) Pub. No.: US 2009/0258713 A1
(43) Pub. Date: Oct. 15, 2009

(54) AUTOMATIC FAIL-OVER FOR GAMING CONTROLLERS

(75) Inventors: SHADI E. ALBOUYEH, RALEIGH, NC (US); STEVEN M. KYLE, HOLLY SPRINGS, NC (US); YEN-KWANG LIN, RALEIGH, NC (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/102,543

(22) Filed: Apr. 14, 2008

(51) Int. Cl. A63F 13/02

(52) U.S. Cl. 463/47

(57) ABSTRACT

A set of controllers can be communicatively linked to a gaming console. One of the controllers can be programmatically designed as an active controller and another can be programmatically designed as a fail-over controller. A failure of an active controller can be determined. Responsive to this determination, the fail-over controller can be automatically substituted for the active controller.

### BACKGROUND OF THE INVENTION

The present invention relates to the field of video game consoles, more particularly, to a fail-over for video game controllers.

The video game market is a thriving one that often utilizes extremely advanced hardware and software. To maximize value per expense and to utilize the inherent capabilities in video gaming consoles, video game consoles have increasingly be extended to provide functionality beyond a video gaming niche. For example, the XBOX original and XBOX 360 consoles have been adapted to function as media player extenders, which permit users to use them as an interactive and network attached interface to a controlling media playing computer (or home server). Additionally, media playing consoles have taken on the role as a movie playing device (e.g., DVD player, BLUERAY player, HD-DVD player). In other words, the gaming console is rapidly becoming a point of convergence for household entertainment and media functions.

In all of these roles the gaming console uses a special or standard controller of the gaming console to control the additional functionality. In absence of this controller, the functionality often cannot be accessed at all. That is, unlike specialty devices (e.g., DVD players that have control buttons to on the player's case) the gaming consoles do not often have redundant controls on the surface for a user to manually utilize. Accordingly, a failure of a controller can cause important functionality provided by the gaming console to be completely inaccessible.

Additionally, gaming consoles are often being used by one or more video game players for the console's primary purpose (playing video games). These games are increasingly time-intensive and plot-driven, which results in mistakes often causing a substantial amount of a video game to be repeated. Worse, when controller malfunctions occur during an online game, some games automatically log a user off, which can be a concern since many online personal game metrics are not resettable and have a lasting negative effect. Thus, a user's online personal suffers significant and lasting harm due to a controller malfunction. Controller malfunctions and their corresponding results during game play decrease the overall gaming experience.

Controller failure is an increasing concern as controller functionality and technology has increased. For example, the WII gaming console introduced a controller with an internal accelerometer that sensed motion in space. While many have found this innovative game control mechanism beneficial from a gaming perspective, new problems have resulted. Namely, in a fast paced game, the console is often rapidly moved in space, resulting in a tendency for the controller to slip from a hand of a user and smash nearby objects (to the detriment of both the controller and the object receiving the impact). Wireless controllers, which are also increasing popular, are prone to electromagnetic interference, range limits, and periodic battery shortfalls (i.e., users forgetting to charge a wireless controller or to replace the batteries), and other issues.

At present, controllers for gaming consoles are becoming increasingly sophisticated and prone to failures. At the same time, they are becoming increasingly important for a positive gaming experience and for controlling enhanced functions of a gaming console. Currently, when controller failures occur, a user must disconnect a failed wired controller and replace it with a working one. During this process, game play of a game continues as if the user stopped providing input, resulting in a serious loss in game play advancement. Current “wireless” controllers are generally paired to a specific key and a failure requires a different wireless controller to be paired to that key manually, resulting in effectively the same problems existent for wired controllers.

### BRIEF SUMMARY OF THE INVENTION

One aspect of the present invention can include a system, method, computer program product, and apparatus for associating controllers to a gaming console. In this aspect, a set of controllers can be communicatively linked to a gaming console. One of the controllers can be programmatically designed as an active controller and another can be programmatically designed as a fail-over controller. A failure of an active controller can be determined. Responsive to this determination, the fail-over controller can be automatically substituted for the active controller.

Another aspect of the present invention can include a gaming console including a central processing unit, a non-persistent memory for storing digitally encoded content, a persistent memory for storing digitally encoded content, and a bus linking the memory and central processing unit. The persistent memory can include a gaming engine and a fail-over engine that are both computer program products usable by the gaming console. The gaming engine can run a set of interactive electronic games, which utilize input from at least one controller during game play. The fail-over engine can automatically substitute a controller in a fail-over state for another controller in an active state responsive to a detected programmatic event. After the substitution, a state of the fail-over controller is changed to an active state and a state of the another controller is an inactive state. Should this failed controller later become usable, it can automatically be adjusted from the inactive state to a default state (such as a fail-over one).

### BRIEF DESCRIPTION OF THE SEVERAL VIEWS OF THE DRAWINGS

FIG. 1 is a schematic diagram of a system of an electronic console having a fail-over capability for its controllers in accordance with an embodiment of the inventive arrangements disclosed herein.

FIG. 2 is a flow chart of a method for implementing fail-over controllers for a gaming console in accordance with an embodiment of the inventive arrangements disclosed herein.

### DETAILED DESCRIPTION OF THE INVENTION

The present invention provides a fail-over for video games controllers. That is, one or more controller is placed in a fail-over state, wherein it functions as a ready reserve. If any controller in an active state experiences a problem, a fall-back controller automatically actives and substitutes for the problematic one. In one embodiment, an in-progress game can automatically pause upon problem detection and remain paused until the replacement controller is in-use. The invention can function with wired and wireless controllers. Additionally, the invention is not limited to controllers can be applied to any of a variety of port connected components, such as headsets, audio keyboards, remote controls, etc.

The present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk-read only memory (CD-ROM), compact disk-read/write (CD-R/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer-usable or computer-readable medium can even include paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

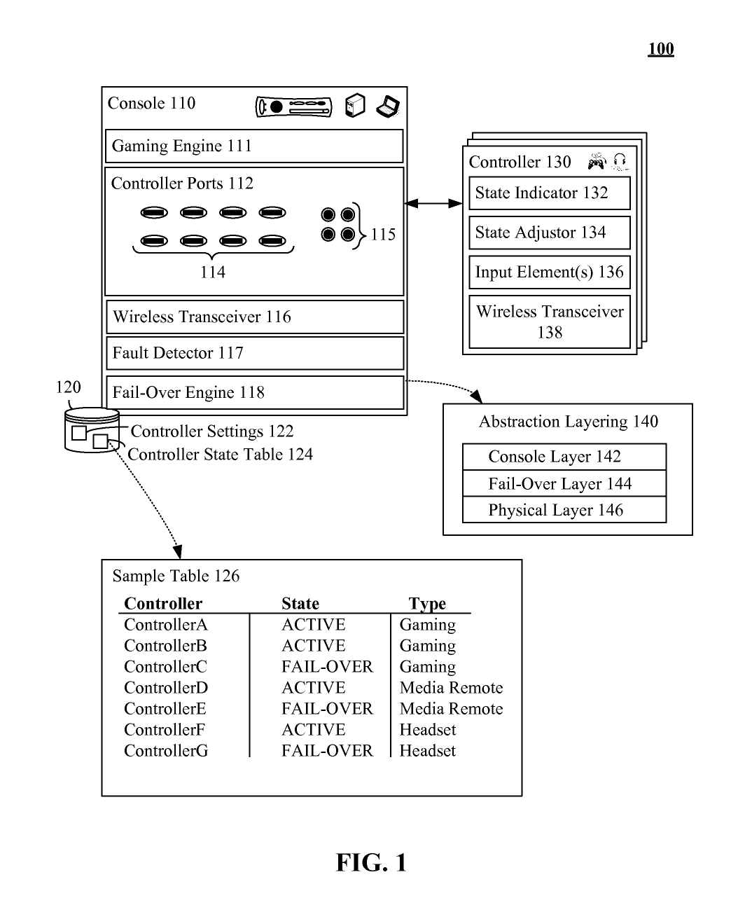

FIG. 1 is a schematic diagram of a system 100 of an electronic console 110 having a fail-over capability for its controllers 130 in accordance with an embodiment of the inventive arrangements disclosed herein. The console 110 can be a gaming console able to play electronic games. Console 110 can include a central processing unit, a non-persistent memory for storing digitally encoded content, a persistent memory (e.g., data store 120) for storing digitally encoded content, a bus linking the memory and central processing units. Data store 120 can store computer program products, such as a gaming engine 111, a fault detector 117, and a fail-over engine 118. Gaming engine 111 can run a plurality of interactive electronic games, which utilize input from at least one controller during game play. The console 110 can also include multiple controller ports 112 and/or a wireless transceiver 116.

One or more users can utilize controllers 130 linked to the console 110 as input entry devices. Unlike conventional arrangements, when one controller 130 fails, another controller 130 (i.e., a back-up controller having a fail-over enablement state) can be automatically substituted. Game play can be optionally paused during the substitution while one controller 130 is switched for another to give a user time to physically shift controllers 130. In another embodiment, the substitution can occur transparently to the running game, which prevents time-out conditions from occurring. This can be particularly important for online gaming, where a forced log-out can be not only inconvenient, but can have a detrimental affect on an online persona.

More specifically, controllers 130 can be paired to the controller ports 112 and/or can be wirelessly connected via wireless transceivers 116 and 118. Each connected controllers 130 can be associated with an enablement state. These enablement states can include an active state, a fail-over state, and an inactive state. When in an active state controller input is conveyed to the console 110 and interpreted. When in a fail-over state, a controller 130 is being used as a back-up to automatically substitute for a one of the active controllers 130 should a failure occur. An inactive state is any state in which a controller 130 is inaccessible for use by console 110. One inactive state can be a failed state, where the controller is unable to properly communicate with the console 110. Controllers 130 can include state indicators 132 and/or state adjustors 134 to indicate and/or adjust the enablement state of a controller 130.

In one embodiment, an abstraction layering 140 technique can be used by the fail-over engine 118. That is, a fail-over layer 144 can function as a layer of abstraction between a console layer 142 and a physical layer 146. The console layer 142 can be the layer that links input from a given controller to activities of the console 110, such as game play interactions. The physical layer 146 can be a communication layer that directly exchanges digital information with the controller 130. The fail-over layer 144 can be a layer that maps physical layer input from a console to a unique identity of the console layer 142. Hence, when applying abstraction layering 140, input is initially received through the physical layer 146, is conveyed through the fail-over layer 144, then to the console layer 142. When a fail-over layer 144 is implemented all programmatic actions performed by engine 118 to switch controllers 130 can execute in this fail-over layer 144.

Other embodiments exist, however, and controller 139 identification keys and corresponding values used by console 110 can be changed, which also results in a fail-over controller 130 being able to be substituted for a problematic one. For example, two controllers 130 (one the fail-over controller and one the problematic one) can be physically connected to two different controller ports 112. Input can be interpreted based upon controller port identifier. When one of the controllers 130 fails to be replaced by the fail-over controller, the reference port identifier of the problematic controller can be overridden with the port identifier associated with the fail-over controller. In another example, two controllers 130 can be wirelessly connected to the console, each having a unique controller id. When one of the controllers 130 fails, to be replaced by the fail-over controller, the controller id for the problematic controller can be overwritten with an id value associated with the fail-over controller.

In one embodiment, different types or sets 114, 115 of controller ports 112 can exist, where different types of controllers 130 are intended to be paired to the different sets 114, 115. For example, ports 114 can be digital serial ports (e.g., a USB port) connected to joysticks, remote controls, and other types of controllers 130 that utilize digital signaling. Ports 115 can be analog audio ports, which can be connected to headsets, speakers, microphones, and other types of controllers that utilize analog signaling. The fail-over engine 118 can identify a type of port and/or controller that has failed and substitute a corresponding type of controller, which is in a fail-over mode.

For example, table 126 is a sample controller state table 124, which shows a set of controllers labeled ControllerA-G. Each controller has an associated state, and an indicated controller type. From the table 126, Controllers A-C are all gaming controllers, where ControllerC is a fail-over controller able to substitute for either ControllerA or ControllerB should either fail. ControllerD and ControllerE are both media remotes, where ControllerE is configured to substitute to ControllerD in an event of a failure. ControllerF and ControllerG are headsets, where ControllerG is configured to substitute for ControllerF should it fail. Specific settings of table 126 and actions to be taken by fail-over engine 118 can be configured using user configurable controller settings 122.

It should be appreciated that any of a variety of programmatic actions and configurable settings 122 can apply to engine 118. For example, one optional setting 122 can permit engine 118 to pause game play in an event of a controller 130 failure. Another setting 122 can direct engine 118 to provide different notification levels, when failures of controllers 130 and/or when controller substitution actions occur. The settings 122 can also change enablement states 130 for controllers connected to various ports 112 and/or wirelessly connected to transceiver 116.

The fault detector 117 can detect any of a variety of problematic conditions, which are to be considered a failure of a controller 130. For example, a wireless controller 130 can be out of transmission range of the wireless transceiver 116. A battery powered controller 130 can run out of charge. A self-check routine of a controller 130 can indicate one or more functions of the controller are non-operational, which transmits a problem notice to detector 117. In another embodiment, detector 117 can periodically “ping” communicatively linked controllers 130 and consider them in a failed state should no response be received within a designated time. These examples are for illustrative purposes only, and the detector 117 can be configured to detect any of a myriad of other conditions indicative of problems using a wealth of known techniques.

As used herein, a controller 130 can be a device which a user is able to utilize to provide input to the console 110. Controller 130 can be wired or wireless. The controller 130 can include a game controller specifically designed to play electronic games or it can be designed to perform an extended function of console 110 unrelated to electronic games, such as being a media playback remote control. One or more input elements 136 can be included on controller 130, which translates user interactions as input. These elements 136 can include, but are not limited to, buttons, force sensor resistors, joysticks, track balls, flight sticks, steering wheels, activity mats, guns, motion detectors, accelerometers, musical instruments, headsets, biometric readers, and the like. The controller 130 can optionally include a wireless transceiver 138 configured to wireless communicate with the console 110.

In one embodiment, the console 110 can be an interactive entertainment computer or electronic device that manipulates display signal of a display device to display a game. The console 110 can be specifically purposes to play video games. These games are often separately purchasable and are contained within required media, which is inserted into console 110 when a game is to be played. A personal computer can also be utilized as a gaming console 110 and is to be considered within a scope of the present invention. Examples of gaming consoles 110 can include, but are not limited to, an ATARI 2600 console, an INTELLIVISION console, a NINTENDO console (including N-64, and the WII), A SEGA GENESIS console, a PLAYSTATION (I, II, and III), an XBOX (original and XBOX 360), and the like. Gaming consoles 110 can also be portable or handheld devices (e.g., NINTENDO GAMEBOY, NINTENDO DS, SEGA GAME GEAR, SONY PSP, etc.).

It should be appreciated that system 100 is has only presented important components of the represented items needed to describe the invention. Other items typical of such a system 100 are presumed to exist. For example, a wireless controller 130 can be presumed to include a battery source, the console 110 can be presumed to be linked to a graphics display and speaker system, and so forth.

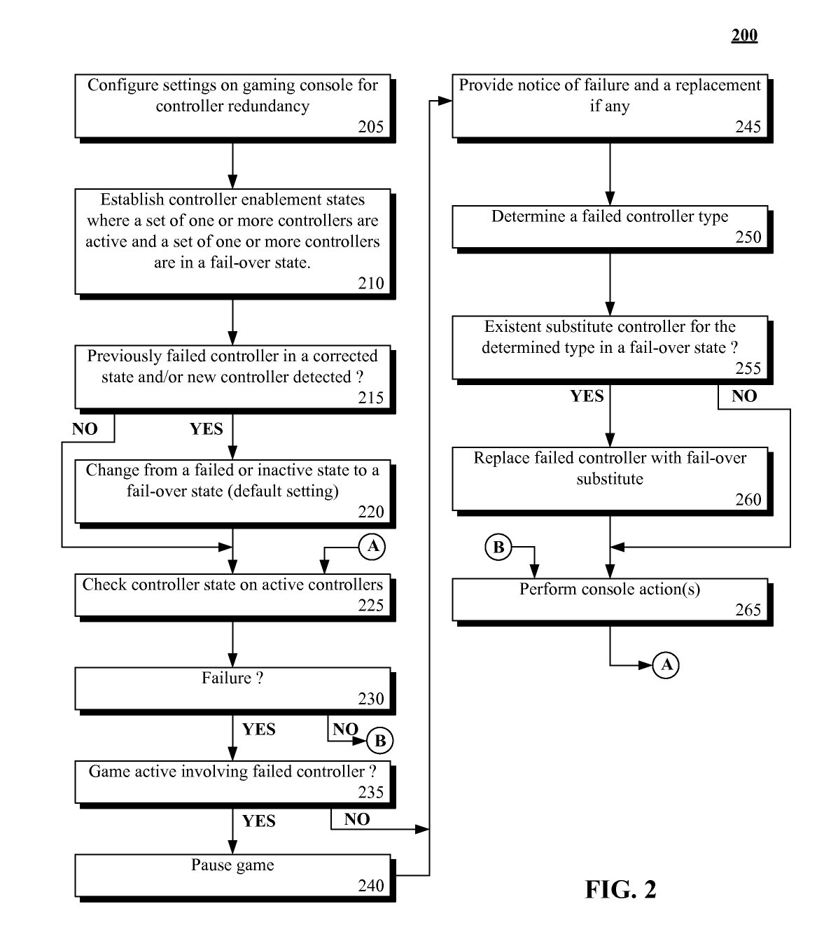

FIG. 2 is a flow chart of a method 200 for implementing fail-over controllers for a gaming console in accordance with an embodiment of the inventive arrangements disclosed herein. Method 200 can be performed in a context of system 100.

The method 200 can begin in step 205 where settings of a gaming console can be configured for controller redundancy. In step 210, a series of controller enablement states can be established for a set of communicatively linked controllers. One or more of the controllers can initially be in an active state. One or more of the controllers can initially be in a fail-over state. In step 215, a check can be performed to determine if controllers current in a failed state have changed their state and/or to see if new controllers have been linked to the console. If so, a default enablement state for these corrected/new controllers can be a fail-over state (or other state depending upon user configurable settings), as shown by step 220. This default can be adjusted by the configuration settings and/or by user actions should a user wish to immediately make a new controller or a corrected controller active.

After new/corrected controllers are determined, the method can proceed to step 215 where controller states for active controllers can be determined. That is, a check can be performed to determine whether any controllers in an active state have failed, as shown by step 230. If so, the method can progress from state 230 to step 235, where a determination can be made as to whether an active game is currently using the failed controller. If so the game can be automatically paused in step 240, after which the method progresses to step 245. In step 245, a notice of controller failure can be presented. This presentation can include a notice appearing on the display connected to the console, can include an indicator appearing on the failed controller, can include an audible warning, and the like. The presented notice can optionally indicate an available substitute controller, if any is exists.

In step 250, a determination can be made regarding the failed controller's type. It should be appreciated that many consoles utilize a standardized bus (e.g., a USB or FIREWIRE based bus) or a modified version of a standardized bus, which permits multiple devices of different types to be concurrently connected to the console. In step 255, the failed controller can be replaced with a fail-over substitute, if one is available, as shown by step 260. This substitution can result in a remapping of ports and/or controller identifiers to a set of active controllers. In step 265, one or more console action(s) can be performed. The method can periodically or intermittently loop back to step 215, where the method can continue to automatically adjust controller states as appropriate.

The diagrams in FIGS. 1-2 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for associating controllers to a gaming console comprising:
communicatively linking a plurality of controllers to a gaming console;
programmatically designating at least one of the plurality of controllers as an active controller;
programmatically designating at least one of the plurality of controllers as a fail-over controller;
determining a failure of the active controller; and
automatically substituting the fail-over controller for the active controller.

2. The method of claim 1, wherein the active controller is connected to the gaming console through a wire line coupled to a first port, and wherein the fail-over controller is connected to the gaming console through a wire line coupled to a second port, wherein said substituting step further comprises:
automatically switching gaming console functionality associated with the first port to the second port.

3. The method of claim 1, wherein the active controller and the fail-over controller are wirelessly linked to the console through at least one wireless transceiver, said method further comprising:
assigning a unique key referred to as an active key to the active controller;
assigning a unique key referred to as a fail-over key to the fail-over controller;
when substituting the fail-over controller, changing value of the fail-over key to the value of the active key.

4. The method of claim 1, further comprising:
indicating an enablement state upon each of the plurality of controllers using state indicator component, wherein the active controller is indicated as being in an active state, and wherein the fail-over controller is indicated as being in a fail-over state.

5. The method of claim 1, further comprising:
automatically pausing game play responsive to determining the failure of the active controller.

6. A computer program product for associating controllers to a gaming console comprising, a computer usable medium having computer usable program code embodied therewith, the computer usable program code comprising: computer usable program code configured to communicatively link a plurality of controllers to a gaming console;
computer usable program code configured to programmatically designate at least one of the plurality of controllers as an active controller;
computer usable program code configured to programmatically designate at least one of the plurality of controllers as a fail-over controller;
computer usable program code configured to determine a failure of the active controller; and
computer usable program code configured to automatically substitute the fail-over controller for the active controller.

7. The computer program product of claim 6, wherein the active controller is connected to the gaming console through a wire line coupled to a first port, and wherein the fail-over controller is connected to the gaming console through a wire line coupled to a second port, the computer usable program code further comprising:
computer usable program code configured to automatically switch gaming console functionality associated with the first port to the second port.

8. The computer program product of claim 6, wherein the active controller and the fail-over controller are wirelessly linked to the console through at least one wireless transceiver, the computer usable program code further comprising:
computer usable program code configured to assign a unique key referred to as an active key to the active controller;
computer usable program code configured to assign a unique key referred to as a fail-over key to the fail-over controller;
computer usable program code configured to change value of the fail-over key to the value of the active key when substituting the fail-over controller.

9. The computer program product of claim 6, further comprising:
computer usable program code configured to indicate an enablement state upon each of the plurality of controllers using state indicator component, wherein the active controller is indicated as being in an active state, and wherein the fail-over controller is indicated as being in a fail-over state.

10. The computer program product of claim 6, further comprising:
computer usable program code configured to automatically pause game play responsive to determining the failure of the active controller.

11. A gaming console comprising:
a central processing unit, a non-persistent memory for storing digitally encoded content, a persistent memory for storing digitally encoded content, a bus linking the memory and central processing units, wherein said persistent memory comprises:
a gaming engine comprising digitally encoded programmatic instructions usable by the gaming console, wherein said gaming engine is configured to run a plurality of interactive electronic games, which utilize input from at least one controller during game play;
a fail-over engine comprising digitally encoded programmatic instructions usable by the gaming console, wherein said fail-over engine is configured to automatically substitute a controller in a fail-over state for another controller in an active state responsive to a detected programmatic event, wherein after the substitution a state of the fail-over controller is changed to an active state and a state of the another controller is at least one of an inactive state and a fail-over state.

12. The gaming system of claim 11, wherein during game play, the another controller is configured to control an interactive entity of one of the interactive electronic games, wherein the fail-over engine is configured to perform the automatic substitution during game play, wherein after the automatic substitution, the fail-over controller controls the interactive entity previously controlled by the another controller.

13. The gaming system of claim 11, wherein said persistent memory further comprises:
computer usable program code configured to automatically pause game play when the fail-over controller is being substituted for the another controller.

14. The gaming system of claim 11, further comprising:
at least two controller ports configured, wherein each controller is configured to connect to one of the controller ports, wherein the fail-over engine is configured to programmatic switch control of an in-game entity from the another controller to the fail-over controller by changing of the two controller ports provides input for the in-game entity.

15. The gaming system of claim 14, wherein the fail-over controller and the another controller are wire line controllers serially connected to the gaming console via the at least two controller ports.

16. The gaming system of claim 11, further comprising:
a wireless transceiver configured to accept wireless communication signals from at least a one of a plurality of controllers communicatively linked to said gaming console, wherein the another controller and the fail-over controller are configured to wirelessly communicate with the gaming console via the wireless transceiver.

17. The gaming system of claim 11, wherein said persistent memory further comprises:
computer usable program code configured to automatically assign a unique key to each of the controllers that are communicatively linked to the gaming console via the wireless transceiver, wherein the fail-over engine is configured to change a value of the unique key assigned to the fail-over controller to a value of the unique key corresponding to the another controller during the substitution.

18. The gaming system of claim 11, wherein said persistent memory further comprises:
a fault detector comprising digitally encoded programmatic instructions usable by the gaming console, wherein said detected programmatic event is an event detected by the fault detector that indicates a problem exists with a controller having an active state.
